(19) United States
(12) Patent Application Publication
(10) Pub. No.: US 2004/0045183 A1
(43) Pub. Date: Mar. 11, 2004

(54) Double-shell dryer

(76) Inventors: Bernd Watzinger, St. Gallen (CH); Bernhard Fritsche, Winterthur (CH); Franz Aebli, Basel (CH)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/380,416

(22) PCT Filed: Sep. 7, 2001
(86) PCT No.: PCT/CH01/00541

(30) Foreign Application Priority Data
Sep. 14, 2000 (DE) 100 45 878.5

(51) Int. Cl. F26B 19/00

(52) U.S. Cl. 34/210

(57) ABSTRACT

The invention relates to a device and method for the drying of damp products, in particular, pasta. According to the invention, the product to be dried in a dryer, is placed in an inner chamber and humid warm air is circulated around the product, in order to ensure a gentle drying thereof. Dry hot air flows in an outer chamber, enclosing the inner chamber, which prevents condensation of water forming in the outer chamber. The inner shell has essentially no heat insulation as the external shell has a conventional heat insulation from the outside air. The dryer construction with a double shell prevents damp from entering the insulation material of the insulating layer through the inner shell and thus forming heat bridges, despite incomplete sealing of the inner chamber.

### CROSS-REFERENCE TO RELATED APPLICATIONS

This application claims priority of PCT Application Serial No. PCT/CHO1/00541, filed Sep. 7, 2001 and Swiss Application No. 100 45 878.5, filed Sep. 14, 2000, the complete disclosures of which are hereby incorporated by reference.

### BACKGROUND OF THE INVENTION

a) Field of the Invention

The present invention relates to a device and a process for the drying of moist products.

b) Description of the Related Art

For the drying of moist products, such as for example wood, farinaceous products, etc, it is particularly important during drying for the drying process to take place in a controlled atmosphere with a suitable “climate”. That is to say that the temperature, the moisture content and the type of drying gas (usually air) must lie in certain ranges, in order that the products are dried without suffering damage, i.e. are brought to a certain target moisture content.

DE 118 204 describes a drying oven for patent leather, with which the leather to be dried is suspended in a drying box. The doors of the double-walled drying box, however, are designed solely as a single wall. Between the inner and the outer wall of the double-walled drying cabinet, heated air is conveyed in a counterflow to the gases introduced into the interior of the drying cabinet. Since the outer and the inner wall of the double-walled drying cabinet are designed identically, heat is both conveyed into the interior of the drying cabinet and also giving off to its external environment. The double-walled drying cabinet is thus surrounded by walls in such a way that, between the outer wall of the double-walled drying cabinet and the masonry wall, there exists a further hollow space through which the hot combustion gases are conveyed that arise when the hot air passed through the double wall of the drying cabinet is heated. Such a drying oven exhibits, on the one hand, a poor thermal efficiency, since a large quantity of heat is given off via the heated masonry work into the environment and is thus not available for heating the drying gases flowing through the interior of the drying cabinet. Since the doors of the drying cabinet do not have any insulation and are directly in contact with the atmospheric air, a strong tendency towards the formation of condensation water on the inside of the doors is to be expected during drying.

DE 40 19 741 describes a drying station for moist materials, in particular for use in paper manufacture. The drying station comprises a housing consisting of a heat-insulating wall for receiving the material to be dried, whereby a thermally heated, gaseous drying medium is introduced in the interior space of the housing and conducted away as a waste gas. A heat medium flows through the housing wall in such a way that, on the inside of the housing wall, a wall temperature exists which avoids the dew point and falling below the vapor-enriched medium located in the interior. Since the drying station is equipped solely on its wall area and its roof area with the housing wall through which a heat medium flows, a considerable quantity of heat is also lost here through the bottom, in the same way as with the drying oven of the preceding paragraph. Here too, there is a raised tendency towards the formation of condensation water at the bottom.

EP 0 177 774 discloses a drying device for web-shaped materials. It includes a drying chamber, through which the web-shaped material to be dried is conveyed and brought into contact with flowing drying gas. Furthermore, there is arranged around the drying chamber a casing, the inner walls of which, together with the outer walls of the drying chamber, bound an intermediate space. The drying gas is heated up in a heater and then flows through the drying chamber, whereby it gives off at least a part of its heat to the drying gas in the intermediate space. Cold drying gas flows through the intermediate space, as a result of which the outer walls of the casing remain relatively cool. Waiting times do not therefore arise when the device is to be dismantled for cleaning. Special measures for the thermal insulation of the casing, however, are not taken.

For the drying of certain products such as wood, or in particular farinaceous products, it is important that the product is not dried too rapidly with air that is too dry and air that is too hot, because otherwise cracks form at the surface of the product due to shrinkage, said cracks possibly extending throughout the whole product. For the drying of such products, therefore, moisture must as a rule also be added to the heated air in order that the relative air humidity is sufficiently high during drying, so as to avoid an excessively steep moisture gradient from the interior to the surface of the product so as to prevent said crack formation.

In order to save energy, such dryers are thermally insulated by means of lagging elements. On account of the process-related high temperature and the high relative air humidity in the dryer with temperatures of typically 90° C. and relative air humidity of 80 to 90% inside the dryer line, condensation occurs on the insides of the lagging elements with the present-day dryer structure, unless there is 100% vapor tightness. In order to prevent penetration of moisture into the insulation material and to retain the thermal insulation effect, it is necessary to design the insulation lagging vapor-tight. This gives rise to high costs for the sealing of the interior space of the dryer against the surrounding atmosphere. However, it has not been possible hitherto to prevent the condensate from escaping from the dryer at some points.

The Problem Underlying the Invention

The problem underlying the invention, therefore, is to prevent the penetration of moisture into the insulation material of the dryer wall/dryer shell, in order to avoid saturation of the insulation material and a leakage from the dryer.

### OBJECT AND SUMMARY OF THE INVENTION

The object of the invention is to solve the problem stated above. This problem is solved, in accordance with the invention, by a device for the drying of moist products, in particular farinaceous products comprising an inner enclosed by an inner shell comprising an inner chamber enclosed by an inner shell for receiving the products to be dried and an outer shell enclosing the inner shell and spaced apart therefrom in such a way that an outer chamber is bounded between the inner shell and the outer shell. The inner shell has a low thermal insulation and the outer shell has a high thermal insulation. A first gas or gas mixture with a first atmosphere can flow through the inner chamber and a second gas or gas mixture with a second atmosphere can flow through the outer chamber. The outer chamber, further, enclosing the inner chamber essentially completely. The outer shell also being provided on its inside with an insulation of insulation material.

Also in accordance with the invention, a process for the drying of moist products, in particular farinaceous products, by a device as described above, comprising the steps of allowing a first gas or gas mixture with a first atmosphere ((Ti, φi, Pi) to flow around the products to be dried in the inner chamber, which gas or gas mixture absorbs and conveys away water vapor escaping from the products and allowing a second gas or gas mixture flowing through the outer chamber to flow around the inner chamber, the atmosphere ((Ta, φa, Pa) and flow rate thereof being such that no condensation occurs in the outer chamber.

Between the inner shell and the outer shell of the dryer, a hot air flow with a low relative air humidity can thus be circulated, which prevents any condensation in the space between the inner shell and the outer shell of the dryer. In other words, the insulation is spatially separated from the vapor barrier by means of this “double shell”, whereby the intermediate space with the hot dry air forms the actual vapor barrier. A very costly vapor barrier commonly used hitherto, consisting of a completely vapor-tight sheet metal directly on the insulating material, is not therefore required.

In a particularly preferred form of embodiment, the inner shell, which is preferably made of sheet metal, exhibits a low thermal insulation, whilst the outer shell exhibits a high thermal insulation from a standard insulation material. In combination with the dry hot air in the intermediate space of this double shell, it is thus ensured that humid air arising due to leaks at the inner shell cannot lead to water condensation either on the outside of the inner shell, or on the inside of the outer shell.

It is expedient for the outer shell to be spaced far enough apart from the inner shell so that the intermediate space of such a double-shell dryer or “dryer in-house” formed by the two shells is accessible.

The outer shell may also consist partially or completely of an inflatable flexible material which is self-supporting by inflation.

When carrying out the process intended by the invention it is essential that hot air flowing around the inner shell possesses a “climate”, in which the temperature, humidity and pressure are at such levels that no condensation can build up in the double shell.

In particular the secondary gas, i.e. the dry, hot air must have a sufficiently high temperature and low moisture content for its dew point to be below the temperature of surrounding air. Condensation on the inside of the outer shell, if badly insulated or not insulated at all against outside air, will thereby be prevented.

It is particularly beneficial to apply a little extra pressure to the dry, hot air in the cavity of the double shell. In this way the flow of leaks is directed to the inside instead of out and any escape of damp, hot air from the inner space is stopped.

To avoid any condensation in the cavity of the double shell when drying pasta at a normal temperature of 25° C. and relative humidity of 50% the dry, hot air in the cavity should have a temperature of around 110° C. and relative humidity of around 2%.

Other advantages, characteristics and possible applications of the invention arise from the following description of a sample design with drawings that have not been reduced.

### BRIEF DESCRIPTION OF THE DRAWINGS

In the drawings:

FIG. 1 is a schematic depiction of the double shell concept of the invention; and

FIG. 2 is a schematic depiction of the complete machine invention aimed at carrying out the intended process.

### DESCRIPTION OF THE PREFERRED EMBODIMENTS

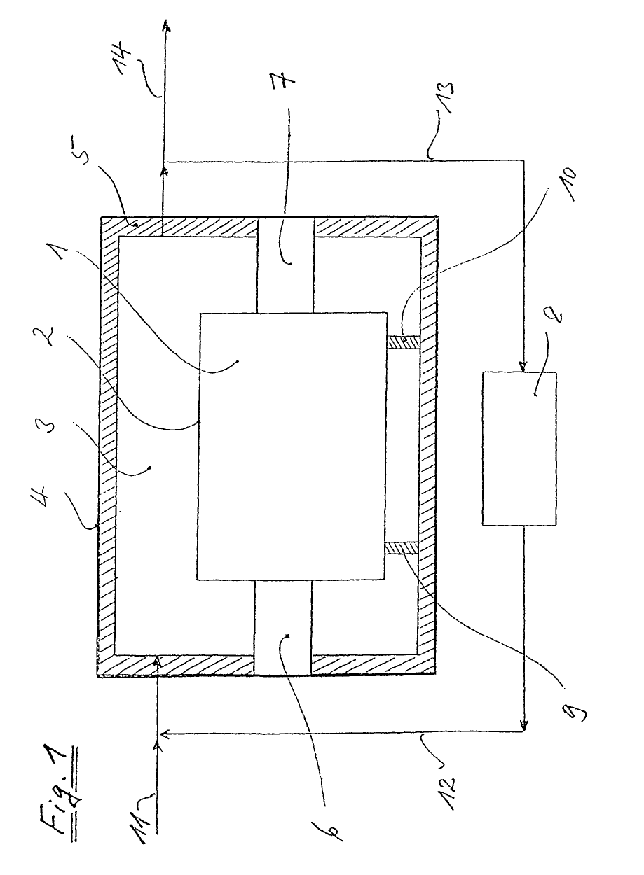

FIG. 1 is a schematic depiction of the invention's double shell concept for a pasta (or farinaceous material) dryer. The drying area consists of an inner chamber 1, surrounded by an inner shell 2. Pasta intended for drying and air that is not too dry (e.g. with a temperature of around 90° C. and relative humidity approx. 80%) are supplied across an entrance channel 6. Dried pasta and “damp-warm” drying air are conducted away over an exit channel. This part of the dryer invention works like a conventional pasta dryer.

In contrast to the conventional dryer, however, the inner chamber 1, bordered by the inner shell, is surrounded by an outer chamber 3, which in turn is bordered by the outer shell 4. Very dry, hot air is conducted through this chamber 3. The shell should preferably be made of sheet steel. As a result of the good heat-conducting property of sheet steel, there is only very slight thermal insulation between the inner chamber 1 and outer chamber 3, but a steam barrier is formed. The outer shell 4 is fitted with insulation 5.

In contrast to other dryers, in which the sheet steel 2 is placed directly onto the insulation, this dryer invention has a spatial division between sheet steel 2 and insulation 5. This cavity, formed by the outer chamber 3, prevents a build-up of water condensation on the outside of the inner shell 2 and the inside of the outer shell 4, with its “dry-hot” air. This avoids the insulation 5 getting soaked and warm bridges being formed.

The dry, hot climate in the double chamber 3 between inner 2 and outer shell 4 is generated by heating the surrounding air with a radiator 8. Some circulating air can also be fed into the surrounding air before or after heating. It is essential that heating should generate dry air with very low relative humidity.

An example of typical operational conditions is a temperature of around 90° C. and approx. 80% relative humidity for the damp, warm air in the drying chamber 1. To maintain a dew point of the dry, hot air of 25° C. in the outer chamber 3, relative humidity must be 2% at a temperature of 110° C. When using circulating air (assume: 25° C., 50% relative humidity) this air can even be heated to 220° C., where relative humidity is then 0.1%. By mixing in fresh air from the surrounding area a dry hot air stream of 110° C. and 2% relative humidity can then be achieved. FIG. 1 shows a pipe section 12, running from the radiator 8 to a fresh air supply pipe 11. Used air from the double chamber 3 is conducted away across a pipe 14, while the circulating air in a pipe 13 is fed back to the radiator 8. The steam supply mentioned at the start in the damp, warm air of the inner chamber 1 is not shown in FIG. 1.

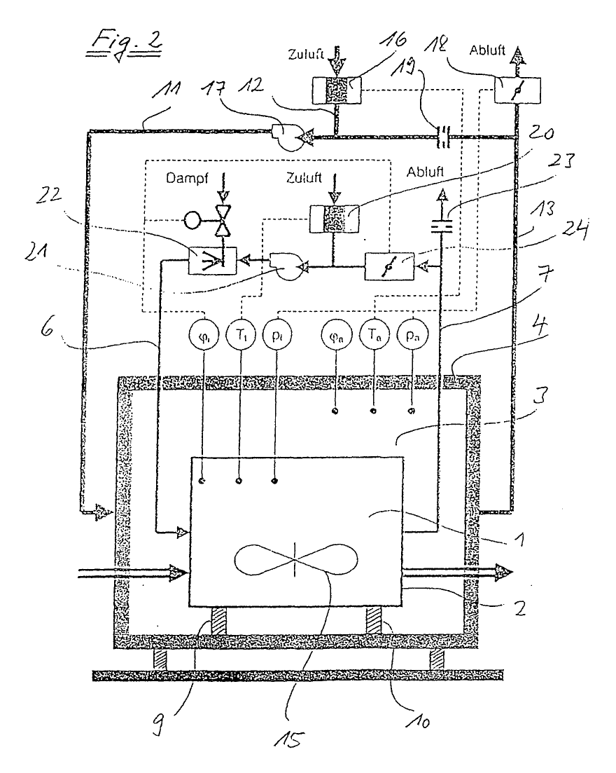

FIG. 2 shows a machine for carrying out the process intended by the invention. While only the “dry-hot” air cycle running through the outer chamber 3 is presented schematically in FIG. 1, FIG. 2 shows both this “dry-hot” air cycle and the “damp-warm” air cycle through the chamber 1. Moreover, it shows a heat exchange 16 and 20 and radial compressor 17 and 21 for each process. The heat exchange 16, 20 provides for necessary heating in the air chamber, while the radial compressor 17, 21 provides for air circulation in each cycle.

Where necessary, steam is brought into the inner cycle of damp, warm air (around 90° C., approx. 80% relative humidity) by means of a steam injector 22. Air pressure in the inner cycle can be adjusted with the assistance of a filter 23 and/or throttle valve 24.

The outer cycle of dry, hot air (110° C., relative humidity 2%) is only heated to preserve very dry and hot air. Air pressure can also be adjusted here with the assistance of the throttle valve 18 and/or filter 19.

It is preferable for the pressure of the “damp-warm” air in the inner cycle to be adjusted to a slightly deeper value than the pressure of the “dry-hot” air in the outer cycle. This means any possible leaks in the inner shell 2 no longer result in damp air being able to get into the cavity 3 in the double shell as a result of leak flows; the flow of the leak is thereby reversed. However we should try to keep mass flow of leaked air (Kg./Std.) as low as possible both from inside to outside and outside to inside.

As shown schematically in FIG. 2, sensors have been provided both in the inner chamber 1 and outer chamber 2 to register climatic parameters of air at any time. For damp, warm air in the inner cycle and dry, hot air in the outer cycle these are Φi or Φa for humidity, Ti and Ta for temperature and Pi or Pa for pressure.

Naturally each actual value registered for climatic parameters may be compared with the desired values we are trying to achieve, so that for each deviation between actual and required values a corresponding trigger is activated for a heat exchange and/or throttle valve and/or filter and/or steam injector 22, by which the corresponding parameters for temperature (Ti, Ta), pressure (Pi, Pa) and humidity (Φi, Φa) are regulated.

A circulating air system 15 has been designed to make the “damp-warm” air in the inner chamber 1 homogeneous. The inner chamber 1, defined by the inner shell 2, stands on two bases 9, 10. This guarantees almost complete circulation flows in the chamber 1 through dry, hot air.

The cavity in the double shell should be installed with enough space to make it accessible. This is important for cleaning, maintenance and repair work. A minimum distance of around 0.5 m between the inner 2 and outer shell 4 has been formed, like a “house” with a door and internal lighting.

The dryer invention is particularly advantageous, because it scarcely requires more energy than a conventional dryer. Through the spatial division of a steam barrier (inner shell 2) and heat barrier or heat insulation (outer shell 4) and with small leak flow from chamber 1 to chamber 2, or vice versa, the dryer has outstanding thickness without any significant extra spending on sealing.

While the foregoing description and drawings represent the present invention, it will be obvious to those skilled in the art that various changes may be made therein without departing from the true spirit and scope of the present invention.

1. Device for drying damp products, in particular pasta, with an inner chamber (1), surrounded by inner casing (2), for the absorption of products to be dried, and an outer casing (4) surrounded by and at such a distance from the inner casing (2) that the boundary of an outer chamber (3) is formed by the inner casing (2) and outer casing (4), where the inner chamber (1) can be passed though by a primary gas or gas mixture with a primary atmosphere and the outer chamber (3) can be passed though by a secondary gas or gas mixture with a secondary atmosphere, characterised by the fact that the inner chamber (1) is essentially fully enclosed by the outer chamber (3).

2. Device as in claim 1, characterised by the fact that the inner casing (2) contains low heat insulation, while the outer casing (4) contains high heat insulation.

3. Device as in claim 1 or 2, characterised by the fact that the inner casing (2) is made of metal, in particular sheet steel, while the outer casing (4) contains a layer of metal, in particular sheet steel, and an insulation layer (5).

4. Device as in one of the preceding claims, characterised by the fact that the outer casing (4) contains a door and the cavity (3) formed by the outer chamber between the inner casing (2) and external casing (4) is accessible.

5. Device as in claim 4, characterised by the fact that at least part of the outer casing (4) is made from a pliable material.

6. Device as in claim 5, characterised by the fact that at least part of the outer casing (4) is capable of bearing its own weight through inflatable, pliable chambers.

7. Process for drying damp products, in particular pasta, via one of the devices outlined in claims 1 to 6, where products to be dried in the inner chamber are circulated by a primary gas or gas mixture with a primary atmosphere (Ti, φi, Pi), which absorbs and draws off steam escaping from products and where the inner chamber is circulated by a secondary gas or gas mixture flowing through the outer chamber, whose atmosphere (Ta, φa, Pa) and speed of current are composed in such a way that no condensation builds up in the outer chamber.

8. Process as in claim 7, characterised by the fact that the secondary gas or gas mixture contains little enough damp and is hot enough for its dew-point to be below the temperature of surrounding air.

9. Process as in claim 7, characterised by the fact that the pressure (Pa) of the secondary gas or gas mixture is slightly higher than pressure (Pi) of the primary gas or gas mixture.

10. Process as in claims 7 or 9, in particular for drying pasta, characterised by the fact that the air of the primary gas flowing through the inner chamber has a temperature between 70° C. and 110° C. and relative humidity of 70% to 90%, while the secondary gas air flowing through the outer chamber has a temperature of at least 110° C. and relative humidity of 1% to 5%.

11. Process as in claim 10, characterised by the fact that the air of the primary gas has a temperature of 80° C. to 100° C., preferably around 90° C., and relative humidity of 75% to 85%, preferably around 80%, and the secondary gas air has a temperature of 110° C. to 120° C., preferably around 115° C.
